(19) United States
(12) Patent Application Publication
(10) Pub. No.: US 2005/0065243 A1
(43) Pub. Date: Mar. 24, 2005

(54) Aqueous material for a system to protect against corrosion

(76) Inventors: Roland Feola, Graz (AT); Maximilian Friedl, Gratkorn (AT); Johann Gmoser, Graz (AT); Willibald Paar, Graz (AT)

Correspondence Address: CONNOLLY BOVE LODGE & HUTZ, LLP, P O BOX 2207, WILMINGTON, DE, 19899, US

(21) Appl. No.: 10/803,362

(22) Filed: Mar. 18, 2004

(30) Foreign Application Priority Data
Sep. 24, 2003 (AT) A 1513/2003

(51) Int. Cl. C08L 63/00

(52) U.S. Cl. 523/461

(57) ABSTRACT

Water-dilutable binders containing reaction products ABC of epoxy resins A, compounds B exhibiting such functional groups as a result of which they are capable of reacting with compounds with epoxy groups, selected from compounds B1 with at least one primary or secondary amino group, compounds B2 with acid groups and compounds B3 with phenolic hydroxyl groups, and fatty acid amides C with at least one amide group and at least one amino group obtainable by reacting fatty acids C1 and amines C2 with at least one secondary amino group and at least one primary amino group, a process for their production and their use for coating metals, mineral substrates and heat-sensitive substrates.

### FIELD OF THE INVENTION

The invention relates to aqueous binders for corrosion protection systems.

### BACKGROUND OF THE INVENTION

Cationically stabilised aqueous binders based on epoxide-amine adducts are part of the state of the art and have been described in the patent literature on numerous occasions. In the field of cataphoretic electrodeposition coating, in particular, they are being successfully used as binders in combination with blocked isocyanates as hardener component (e.g. EP-A 0 249 850, EP-A 0 004 090, DE-A 3041 700, DE-A 33 00 583, DE-A 33 11 513).

Such systems always require stoving at temperatures of approximately 160° C. to approximately 180° C. in order to liberate the reactive groups of the blocked isocyanate thus providing crosslinked coatings giving good protection against corrosion.

From European Patent Application EP-A 1 208 187, certain water-dilutable epoxide-amine adducts are known which, without additional hardener and by purely physical drying, lead to coatings exhibiting an excellent adhesion to metals and providing good protection against corrosion.

In EP-A 1 123 034, conversion products of epoxy resins with fatty acid-modified epoxide-amine adducts as binders for air-drying corrosion-resistant coatings are described.

The two latter binder classes, however, require further improvement in spite of their already providing good protection against corrosion.

Surprisingly enough, it has now been found that it is possible to produce, from conversion products of epoxy resins with amine-functional fatty acid amides together with further epoxy-reactive components such as amines and hydroxyl-functional substances, binders for coatings which provide markedly improved protection against corrosion on metallic substrates compared with otherwise identical cationic systems not modified with fatty acid amides.

### SUMMARY OF THE INVENTION

Consequently, the invention relates to water-dilutable binders containing conversion products ABC of epoxy resins A, compounds B carrying such functional groups as a result of which they are capable of reacting with compounds with epoxy groups, selected from compounds B1 with at least one primary or secondary amino group, compounds B2 with acid groups and compounds B3 with phenolic hydroxyl groups, and fatty acid amides C with at least one amide group and at least one hydrogen atom bound to a nitrogen atom, this nitrogen atom not being part of an amide group or a urethane group. The fatty acid amides C can be obtained by reacting fatty acids C1 and amines C21 with at least one primary amino group and at least one secondary amino group or amines C22 with at least two primary amino groups.

### DETAILED DESCRIPTION OF THE PREFERRED EMBODIMENTS

The epoxy resins A can be aliphatic or aromatic epoxy compounds with at least one, preferably at least two epoxy groups per molecule. Preferably, aliphatic monoepoxides and diepoxides A1 or A2 are used, glycidyl ethers of aliphatic monohydric alcohols with 4 to 40 carbon atoms and glycidyl esters of aliphatic monocarboxylic acids with 5 to 20 carbon atoms being preferred as monoepoxides A1, the aliphatic alcohols and aliphatic carboxylic acids exhibiting in a further preferred manner at least one tertiary or quaternary carbon atom. The diepoxides A2 are selected from the group consisting of diglycidyl ethers of dihydric aliphatic alcohols with 4 to 20 carbon atoms, diglycidyl ethers of dihydroxy polyoxyalkylenes such as polyethylene glycol and polypropylene glycol, diglycidyl esters of dicarboxylic acids with 2 to 40 carbon atoms and diglycidyl ethers of divalent phenols with resorcinol, hydroquinone, dihydroxydiphenyl, dihydroxydiphenyl ether, bis(4-hydroxyphenyl)sulphone, 4,4′-dihydroxybenzophenone, 2,2-bis(4-hydroxyphenyl)propane (bisphenol A), bis(4-hydroxyphenyl)methane (bisphenol F) and 2,2-bis(4-hydroxyl-3,5-dimethylphenyl)propane (tetramethyl bisphenol A). Bisphenol A-diglycidyl ether and hexane diol diglycidyl ether as well as polypropylene glycol diglycidyl ether are preferred.

The compounds B1 with at least one primary or secondary amino group are preferably those in which the amino groups are bound to aliphatic carbon atoms. Aliphatic compounds which may be linear, branched or cyclic and have 2 to 40 carbon atoms are particularly preferred. Moreover, compounds B11 which carry at least one hydroxyl group apart from at least one secondary or primary amino group and compounds B12 which carry at least one primary and at least one tertiary amino group are preferred. Further preferred amines B13 are those which have at least two primary amino groups and at least one secondary amino group. It is also preferable to use mixtures which contain at least two different amines of the above-mentioned class of compounds, preferably those belonging to different classes. Ethanol amine, propanol amine, diethanol amine, dipropanol amine, 4-hydroxybutyl amine, N-methyl ethanol amine, N-ethyl ethanol amine, N,N-dimethyl aminoethyl amine and N,N-dimethyl aminopropyl amine, N-(2-aminoethyl) piperidine, N-(2-aminoethyl)pyrrolidine, N-(2-aminoethyl)piperazine; diethylenetriamine, triethylene tetramine, tretaethylenepentamine and pentaethylenehexamine, dipropylenetriamine, tripropylenetetramine and polyethylene imine, in particular, are suitable amines. N,N-diethanolamine, diethylenetriamine and triethylenetetramine as well as N,N-dimethyl aminopropylamine are particularly preferred.

Suitable compounds B2 with acid groups are preferably aliphatic monocarboxylic acids with 2 to 40 carbon atoms which may be linear, branched and cyclic and preferably have at least one olefinic double bond. Unsaturated fatty acids such as oleic acid, linoleic acid, linolenic acid, palmitoleic acid, erucic acid and ricinoleic acid as well as mixtures obtained from natural fats containing at least a mass fraction of 20%, preferably at least 30% of unsaturated fatty acids. Among the fatty acid mixtures obtained from natural fats, linseed oil fatty acid and tall oil fatty acid are particularly preferred.

Suitable compounds B3 with phenolic hydroxyl groups include of monophenols and diphenols such as phenol, cresols, xylenols, resorcinol, hydroquinone, dihydroxydiphenyl, dihydroxydiphenyl ether, bis(4-hydroxyphenyl)sulphone, 4,4′-dihydroxybenzophenone, 2,2-bis(4-hydroxyphenyl)propane (bisphenol A), bis(4-hydroxy phenyl)methane (bisphenol F) and 2,2-bis(4-hydroxy-3,5-dimethylphenyl)propane (tetramethyl bisphenol A). Bisphenol A and bisphenol F and their mixtures are particularly preferred.

The fatty acid amides C are derived from fatty acids C1 with 6 to 40 carbon atoms, preferably 8 to 36 carbon atoms and preferably at least one olefinic double bond, where it is preferred in the case of two or more double bonds that these are not conjugated, and amines C2 which are preferably linear, branched or cyclic aliphatic amines with 4 to 20 carbon atoms and at least one primary and at least one secondary amino group. The amines C2 are selected from amines C21 with a primary amino group and a secondary amino group and amines C22 with at least two primary amino groups. Suitable amines C21 are, for example, N-(2-amino ethyl)-piperazine and 2-(2-aminoethyl)pyrrolidine. Moreover, oligo and polyalkylene amines with 2 to 8 carbon atoms in the alkylene group, in particular diethylenetriamine, triethylenetetramine, tetraethylenepentamine and their higher analogues, 3-(2-aminoethylamino)propylamine, dipropylenetriamine and tripropylenetetramine, N,N-bis(4-aminobutyl)amine (bistetramethylenetriamine) and N,N′-bis(6-aminobutyl-1,-diaminobutane (tristetramethylenetetramine) as well as N,N-bis(6-aminohexyl)amine (bishexamethylenetriamine) and N,N′-bis(6-aminohexyl)-1,6-diamino butane are preferred as amines C22.

The manufacture of the binder according to the invention is preferably effected in such a way that, firstly, fatty acid amides C having at least one secondary and/or primary amino group are synthesised by reacting the fatty acids C1 with the amines C2. These amino-functional fatty acid amides C are subsequently mixed with at least two of compounds B, where compounds B from at least two different classes of B1, B2 and B3 are used. Subsequently, a first portion of an epoxide A is added, preferably, a monoepoxide A1. The reaction mixture is heated to a temperature of preferably 60° C. to 100° C. and reacted until no more free epoxy groups can be detected. Preferably, at least one further compound B and a second portion of an epoxide A are subsequently added, now preferably a diepoxide A2. The reaction mixture is then reacted until no more free epoxy groups can be detected. Subsequently, this reaction product is dispersed in water to which a neutralising agent had previously been added and the dispersion formed is reacted with a further portion of a diepoxide A2 and reacted until all epoxy groups have been fully consumed.

The binder thus produced can be used directly or in the form of a pigmented coating to coat surfaces. The coatings thus produced can be applied by all common methods such as brush application, blade application, atomising, spraying, using application dies or by electrostatic or electrophoretic deposition. The coatings are physically drying, they consequently require no additional hardener. However, it is possible to accelerate hardening at room temperature or elevated temperature by adding crosslinkers such as non-blocked or blocked multifunctional isocyanates or aminoplast resins. The coatings produced with the binders according to the invention are particularly suitable for coating metals such as iron, steel, aluminium, for mineral substrates such as stone and concrete and, because of their drying at room temperature, in particular for heat-sensitive substrates such as plastics, paper and cardboard.

The invention is further illustrated by the following examples.

### EXAMPLES

In these examples the following abbreviations are used:
BHMTA Bishexamethylene triamine (molar mass 215 g/mol)
TOFS Tall oil fatty acid (molar mass 280 g/mol)
CE ®Cardura E10 (molar mass 250 g/mol)
BA Bisphenoyl A (molar mass 228 g/mol)
DMAPA N,N-dimethyl amino propyl amine (molar mass 102 g/mol)
EP Liquid diepoxy resin based on bisphenol A (molar mass 380 g/mol)
AA Acetic acid (molar mass 90 g/mol)
DETA Diethylene triamine (molar mass 103 g/mol)
TETA Triethylene tetramine (molar mass 146 g/mol)
PFA Peanut oil fatty acid (molar mass 280 g/mol)
INA Isononanoic acid (molar mass 158 g/mol)
DOLA Diethanol amine (molar mass 105 g/mol)
HDA Hexamethylene diamine (molar mass 116 g/mol)

### Example 1

### Preparation of the Amino-Functional Fatty Acid Amides

Amino-Functional Fatty Acid Amide A1

215 g (1.0 mol) of BHMTA were heated to 40° C. 560 g (2.0 mol) of TOFS were added with stirring in the course of 15 minutes and, on completion of the addition the batch was heated, by exploiting the slight exothermal development occurring (heat of neutralisation), within 1 hour to 150° C. By separating the reaction water formed, the temperature was maintained at 150° C. for a further 3 hours initially and then continuous heating to approximately 180° C. was carried out over approximately 2 hours. This temperature was maintained until an amine value of approximately 76 mg/g was reached (corresponding to 1 mol of secondary amino groups in the batch). A brown solid forming a paste at room temperature with an amine value of 75.3 mg/g and an acid number of 8.1 mg/g was obtained.

In an manner analogous to A1, further amino-functional fatty acid amides (A2 to A5 were produced according to the details provided in table 1:

TABLE 1
Composition of the fatty acid amides

| | | Fatty acid amide | | | |
|---|---|---|---|---|---|
| | | A2 | A3 | A4 | A5 |
| Amine | Mass in g | 215 | 103 | 146 | 146 |
| | Amount of substance in mol | 1 | 1 | 1 | 1 |
| | Type | BHMTA | DETA | TETA | TETA |
| Fatty acid | Mass in g | 560 | 316 | 560 | 316 |
| | Amount of substance in mol | 2 | 2 | 2 | 2 |
| | Type | PFA | INA | TOFS | INS |
| Product | Mass in g | 739 | 383 | 670 | 426 |
| | Amine value in mg/g | 74.8 | 144 | 164.9 | 261.9 |
| | Residual acid number in mg/g | 6.9 | 7.7 | 6 | 7.4 |

### Example 2

### Preparation of the Aqueous Binder

Aqueous dispersion of a cationic binder B1 containing amide structures.

739 g (1.0 mol) of the amine-functional fatty acid amide A1, 280 g (1.0 mol) of TOFS and 222 g (1.03 mol) of BHMTA were heated to 90° C. and stirred until a clear melt had formed. Within one hour, 774 g (3.1 mol) of CE were then added, the temperature being maintained at 85° C. to 90° C. by cooling. After stirring for a further hour at 85° C., 968 g (4.24 mol) of BA, 206 g (1.96 mol) of DOLA and 184 g (1.8 mol) of DMAPA were added in this sequence. After a clear melt had formed, a first portion of 3,230 g (8.5 mol) of the epoxy resin EP was added at 80° C. with ninety minutes, during which process the temperature had risen by exothermal development to 150° C. The temperature of 150° C. was maintained until no more free epoxy groups were detectable (approximately 1 hour). Into a dilution vessel, 8,800 g of water and 450 g of an aqueous acetic acid solution (concentration 60%, 3.0 mol) were introduced and the resin from the reaction vessel was added within thirty minutes. The temperature of the mixture was adjusted to 70° C., homogenisation was carried out for one hour with stirring. Subsequently, dilution was carried out with water in portions to a mass fraction of solids of 45%. The aqueous dispersion thus obtained was heated to 80° C., a second portion of 400 g (1.05 mol) of the epoxy resin EP was then added and the mixture maintained at 70° C. to 80° C. with stirring until no more free epoxy groups were detectable. The end product obtained had a Staudinger index of 60 cm³/g measured at 20° C. in dimethyl formamide.

In an analogous manner to the dispersion of binder B1, further binder dispersions were prepared according to the details given in table 2. To prepare binder B7, an adduct V of 1 mol of HDA+2 mol of CE (molar mass 616 g/mol), i.e. an amide-free secondary diamine, was used instead of the amino-functional fatty acid amide.

TABLE 2
Surface Specialties Austria GmbH

| | | | | Epoxid-reactive | | | | | |
|---|---|---|---|---|---|---|---|---|---|
| | Amide | | | substances | | | Epoxy resins | | |
| | | Amount of | | | Amount of | | | Amount of | |
| | Mass | substance in | | Mass | substance in | | Mass | substance in | |
| Example | in g | mol | Type | in g | mol | Type | in g | mol | Type |
| B1 | 739 | 1 | A1 | 280 | 1 | TOFS | 774 | 3.1 | CE |
| | | | | 222 | 1.03 | BHMTA | 3230 | 8.5 | EP (1) |
| | | | | 968 | 4.24 | BA | 400 | 1.05 | EP (2) |
| | | | | 206 | 1.96 | DOLA | | | |
| | | | | 184 | 1.8 | DMAPA | | | |
| B2 | 670 | 1 | A4 | 560 | 2 | TOFS | 3230 | 8.5 | EP (1) |
| | | | | 935 | 4.1 | BA | 400 | 1.05 | EP (2) |
| | | | | 210 | 2 | DOLA | | | |
| | | | | 184 | 1.8 | DMAPA | | | |
| B3 | 383 | 1 | A3 | 560 | 2 | TOFS | 774 | 3.1 | CE |
| | | | | 215 | 1 | BHMTA | 3230 | 8.5 | EP (1) |
| | | | | 968 | 4.24 | BA | 380 | 1 | EP (2) |
| | | | | 105 | 1 | DOLA | | | |
| | | | | 184 | 1.8 | DMAPA | | | |
| B4 | 739 | 1 | A2 | 280 | 1 | TOFS | 750 | 3 | CE |
| | | | | 215 | 1 | BHMTA | 3420 | 9 | EP (1) |
| | | | | 935 | 4.1 | BA | 380 | 1 | EP (2) |
| | | | | 210 | 2 | DOLA | | | |
| | | | | 184 | 1.8 | DMAPA | | | |
| B5 | 426 | 1 | A5 | 280 | 1 | TOFS | 750 | 3 | CE |
| | | | | 215 | 1 | BHMTA | 3420 | 9 | EP (1) |
| | | | | 935 | 4.1 | BA | 380 | 1 | EP (2) |
| | | | | 210 | 2 | DOLA | | | |
| | | | | 184 | 1.8 | DMAPA | | | |
| B6 | 670 | 1 | A4 | 456 | 4 | BA | 774 | 3.1 | CE |
| | | | | 210 | 2 | DOLA | 3230 | 8.5 | EP (1) |
| | | | | 184 | 1.8 | DMAPA | 380 | 1 | EP (2) |
| B7 | 616 | 1 | V | 560 | 2 | TOFS | 3230 | 8.5 | EP (1) |
| | | | | 935 | 4.1 | BA | 400 | 1.05 | EP (2) |
| | | | | 210 | 2 | DOLA | | | |
| | | | | 184 | 1.8 | DMAPA | | | |

| | Neutralising agent | | | | | |
|---|---|---|---|---|---|---|
| | (Acetic acid) | | | | Proportion of | |
| | | Amount of | Solid | Staudinger | solids by | Viscosity at |
| | Mass | substance in | resin | index | weight | 23° C. |
| Example | in g | mol | in g | in cm³/g | in % | in mPa · s |
| B1 | 270 | 3 | 7273 | 60 | 40 | 890 |
| B2 | 246 | 2.73 | 6435 | 57.4 | 37.1 | 1536 |
| B3 | 230 | 2.55 | 7029 | 64.3 | 39.8 | 1040 |
| B4 | 243 | 2.7 | 7356 | 71.3 | 41.1 | 998 |
| B5 | 234 | 2.6 | 7034 | 65.8 | 40.8 | 894 |
| B6 | 270 | 3 | 6174 | 59.1 | 35.3 | 1081 |
| B7 | 246 | 2.73 | 6381 | 58.8 | 36.8 | 860 |

The first portion of the epoxide EP is referred to as EP (1) and the second portion as EP (2).

### Example 3

### Application Test

Aqueous coatings were produced according to the following recipe given in table 3:

TABLE 3
Coating formulation (mass of the components in g):

| | |
|---|---|
| 22.90 | Water |
| 6.65 | ® Additol VXM 6208 (dispersant) (1) |
| 12.55 | ® Kronos 2059 (2) |
| 18.85 | ® Bayferrox 130 BM (3) |
| 9.65 | ® Blanc fixe N (4) |
| 15.60 | Zinc phosphate ZPA (5) |
| 13.80 | Talcum IT extra (6) |
| 100.00 | Pigment paste |
| 63.00 | Binder (B1 to B7 from Table 2) |
| 163.00 | Pigmented coating |

(1) Surface Specialties Austria GmbH
(2) Kronos Titan GmbH
(3) Bayer AG
(4) Sachtleben GmbH
(5) Heubach GmbH
(6) Dr. Alberti/Bad Lauterberg D

For this purpose, a mixture was initially produced from the components indicated above in the sequence specified, this mixture was then dispersed for thirty minutes in a dissolver at 300 min⁻¹. This pigment paste was then converted into a coating by adding binder B1 to B7.

The coating thus obtained was applied to a non-phosphated panel of sheet steel in a dry film thickness of 40 μm to 50 μm.

TABLE 4
Results of the coating test

| | Binder | | | | | | |
|---|---|---|---|---|---|---|---|
| | | | | | | | B7 |
| | B1 | B2 | B3 | B4 | B5 | B6 | Comparison |
| Mechanical testing: | | | | | | | |
| Pendulum hardness after 7 days' storage in s | 51 | 44 | 63 | 66 | 59 | 90 | 77 |
| Impact/direct ° in in · lb; J | 45; 5.1 | 50; 5.6 | 40; 4.5 | 50; 5.6 | 30; 3.4 | 30; 3.4 | 40; 4.5 |
| Erichsen indentation § in | 7 | 8 | 7 | 5 | 6 | 5 | 5 |
| mm | | | | | | | |
| Cross hatch* | 0 | 0 | 0 | 0 | 0 | 0 | 0 |
| Corrosion testing: | | | | | | | |
| Salt spray test ˜ | | | | | | | |
| Degree of rusting # | 1 | 1 | 1 | 1 | 1 | 1 to 2 | 3 |
| Seepage undemeath in mm | 2 | 3 | 2 | 2 | 3 | 3 | 10 |

(1 in · lb = 25.4 mm · 0.453592 kg · 9.81 s⁻² = 112.8 mJ)
Explanations:
° ISO 6272
§ DIN 53156
*Assessment of cross hatch according to DIN EN ISO 2409
˜ DIN EN ISO 7253
# Assessment of the degree of rusting
0 No rust stains
1 Occasional rust stains
2 Approximately 20% of the surface covered by rust stains
3 Approximately 40% of the surface covered by rust stains
4 More than 50% of the surface covered by rust stains
5 Entire surface rusty

Whereas the mechanical values of the panel of sheet steel coated with the comparative coating using binder B7 are within the range of the values of the coatings prepared with the binder according to the invention, a considerable improvement in the properties providing protection against corrosion is exhibited both regarding the degree of rusting in the salt spray test (from a value of “3” in the comparison to “1” or “1 to 2” for the coatings prepared according to the invention) but in particular also in the seepage underneath. Such an improvement was unexpected.

In the case of coatings containing reaction products of epoxy resins with the amino-functional fatty acid amides according to the invention, considerable improvements in the coatings providing protection against corrosion are thus achieved for base metals.

1. Water-dilutable binders containing reaction products ABC of epoxy resins A, compounds B having such functional groups as a result of which they are capable of reacting with compounds with epoxy groups, selected from compounds B1 with at least one primary or secondary amino group, compounds B2 with acid groups and compounds B3 with phenolic hydroxyl groups, and fatty acid amides C with at least one amide group and at least one amino group obtained by reacting fatty acids C1 and amines C2 with at least one secondary and at least one primary amino group.

2. The water-dilutable binders according to claim 1 characterised in that the fatty acid amides C contain at least two amide groups and at least one secondary amino group.

3. The water-dilutable binders according to claim 1 characterised in that the fatty acids C1 have 6 to 40 carbon atoms and at least one olefinic double bond.

4. The water-dilutable binders according to claim 1 characterised in that the amine C2 are linear, branched or cyclic aliphatic amines with 4 to 20 carbon atoms and at least one primary and at least one secondary amino group selected from the group consisting of amines C21 with a primary amino group and a secondary amino group and amines C22 with at least two primary amino groups.

5. The water-dilutable binders according to claim 1 characterised in that aliphatic or aromatic epoxy compounds with at least one epoxy group per molecule are used as compounds A, the monoepoxides A1 being selected from the group consisting of glycidyl ethers of aliphatic monohydric alcohols with 4 to 40 carbon atoms and glycidyl esters of aliphatic monocarboxylic acids with 5 to 20 carbon atoms and the diepoxides A2 are selected from the group consisting of glycidyl ethers of dihydric aliphatic alcohols with 4 to 20 carbon atoms, diglycidyl ethers of dihydroxy polyoxyalkylenes such as polyethylene glycol and polypropylene glycol, diglycidyl esters of dicarboxylic acids with 2 to 40 carbon atoms, and diglycidyl ethers of divalent phenols.

6. The water-dilutable binders according to claim 1 characterised in that, in the compounds B1, the amino groups are bound to aliphatic carbon atoms, that the compounds B1 are linear, branched or cyclic and have 2 to 40 carbon atoms, wherein compounds B1 are selected from the group consisting of compounds B11 which, apart from at least one secondary or primary amino group, have at least one hydroxyl group, compounds B12 which have at least one primary and at least one tertiary amino group, and compounds B13 which have at least two primary amino groups and at least one secondary amino group.

7. The water-dilutable binders according to claim 1 characterised in that the compounds B2 are aliphatic linear, branched or cyclic monocarboxylic acids with 2 to 40 carbon atoms having at least one olefinic double bond.

8. The water-dilutable binders according to claim 1 characterised in that the compounds B3 are selected from the group consisting of monophenols and diphenols.

9. A process for the preparation of water-dilutable binders according to claim 1 characterised in that
in the first step, fatty acid amides C are synthesised by reacting the fatty acids C1 with the amines C2, which fatty acid amides C have at least one secondary and/or primary amino group,
these amino-functional acid amides C are subsequently mixed, in the second step, with at least two of the compounds B, where compounds B from at least two different classes of B1, B2 and B3 are used,
subsequently, in step three, a first portion of an epoxide A is added and reacted until no more free epoxy groups are detectable,
subsequently, this reaction product is dispersed in water to which a neutralising agent had previously been added and the dispersion formed is reacted in the fourth step with a further portion of a diepoxide A2 and reacted further until all epoxy groups are completely consumed.

10. The process according to claim 9 characterised in that, following the third step, at least one further compound B and a second portion of an epoxide A are added and the reaction mixture is reacted until no more free epoxy groups are detectable.

11. The process according to claim 10 characterised in that the epoxide added as second portion is a diepoxide A2.

12. A method of use of the water-dilutable binders according to claim 1 comprising coating metals, mineral substrates, plastics, paper and board.

13. A method of use of the water-dilutable binders according to claim 1 comprising combining the binders of claim 1 with hardeners selected from the group consisting of blocked and non-blocked multifunctional isocyanates and aminoplast resins to formulate coatings.
